(19) United States
(12) Patent Application Publication
(10) Pub. No.: US 2026/0368620 A1
(43) Pub. Date: Nov. 19, 2026

(54) INTEROPERABILITY SYSTEM FOR MACHINE-LEARNING MODELS

(71) Applicant: Red Hat, Inc., Raleigh, NC (US)

(72) Inventors: Leigh Griffin, Waterford (IE); Cathal O'Connor, Waterford (IE)

(73) Assignee: Red Hat, Inc., Raleigh, NC (US)

(21) Appl. No.: 19/208,452

(22) Filed: May 14, 2025

(51) Int. Cl. G06N 20/00

(52) U.S. Cl. CPC G06N 20/00

(57) ABSTRACT

An interoperability system is provided for machine-learning models. In one example, the system can automatically analyze an operational configuration for a machine-learning model executing on a computing node. The system can generate a translation schema for the machine-learning model based on the operational configuration. The system can then receive an electronic request in a first format, the electronic request being intended for the machine-learning model. The system can generate a translated request by translating the electronic request from the first format into a second format based on the translation schema, the second format being different from the first format. The system can then transmit the translated request to the machine-learning model for processing.

### TECHNICAL FIELD

The present disclosure relates generally to machine learning. More specifically, but not by way of limitation, this disclosure relates to an interoperability system for machine-learning models.

### Background

Machine-learning models such as neural networks are used in a variety of industries to enable computers to learn patterns and make predictions or decisions. These models are designed to process large volumes of data, extract meaningful insights, and adapt to new information, making them invaluable across diverse applications such as image recognition, natural language processing, predictive analytics, and autonomous systems. Recent innovations in machine learning have focused on improving model efficiency, accuracy, and scalability, including the development of complex deep learning architectures and new training techniques.

### BRIEF DESCRIPTION OF THE DRAWINGS

FIG. 1 shows a block diagram of an example of an interoperability system for machine-learning models according to some aspects of the present disclosure.

FIG. 2 shows an example of integrating a translation layer into a machine-learning model’s architecture according to some aspects of the present disclosure.

FIG. 3 shows a block diagram of an example of an interoperability system for machine-learning models according to some aspects of the present disclosure.

FIG. 4 shows a flowchart of an example of a process for enabling interoperability between machine-learning models according to some aspects of the present disclosure.

### DETAILED DESCRIPTION

Machine-learning models can be deployed on various computing nodes of a distributed computing environment, such as an Internet of Things (IOT) mesh network. The same base model or distinct models may be deployed on the computing nodes. Each machine-learning model may be tailored to the specific operating environment of its computing node to allow for variations in context, location, and environment factors. For example, even when the same base model is initially deployed on two different computing nodes, the models may then undergo a certain amount of configuration to tailor them to the node’s computing environment. This customization can enable the models to function effectively within their specific computing environments. Over time, even identical base models deployed on different computing nodes can evolve divergently due to continuous learning and adaptive adjustments, creating specialized models that reflect their localized operational contexts. For example, as different hardware or application programming interface (API) endpoints become available or unavailable to a given machine-learning model over time, its operational configuration may diverge from that of a similar model operating on another computing node. While this diversity is beneficial for the effectiveness of each machine-learning model in its operating environment, it also introduces significant challenges to achieving seamless interoperability, as the varying configurations and behaviors of the models may complicate their coordination and communication.

Some examples of the present disclosure can overcome one or more of the abovementioned problems by providing an interoperability system that can translate communications to and from specialized formats tailored to individual machine-learning models. The interoperability system can automatically analyze the operational configuration of a machine-learning model executing on a computing node and generate a translation schema based on the model’s specific configuration. Thereafter, incoming communications intended for the machine-learning model can be received in a standardized, model-agnostic format. Using the translation schema, the interoperability system can translate these communications into a specialized format that aligns with the specific operational configuration of the machine-learning model. Similarly, outputs generated by the machine-learning model in its specialized format can be translated back into the standardized format, ensuring consistency and compatibility across diverse and/or divergent machine-learning models within the network. By facilitating bidirectional translation between standardized and specialized formats, the interoperability system can enable seamless communication while accounting for the unique configurations of individual machine-learning models.

As noted above, the operational configurations of machine-learning models deployed within a network can evolve over time. Some such evolutions may be organic and thus unpredictable - for instance, such evolutions may be due to automated learning/feedback loops or unanticipated software/hardware failures. Other evolutions may be deliberate to account for changes in hardware, software, location, laws or regulations, or security policies. To account for either of these scenarios, the interoperability system can iteratively (e.g., periodically) perform the above process. By continuously analyzing the evolving operational configurations of each machine-learning model and updating their corresponding translation schemas, the interoperability system can ensure that communication remains accurate and seamless. This iterative approach allows the interoperability system to adapt to the ongoing evolution of the machine-learning models, maintaining compatibility and functionality across the network as the capabilities and operational contexts of the machine-learning models are refined.

In some examples, the interoperability system can automatically update a machine-learning model’s architecture to include one or more translation layers that implement the translations described above. For example, the interoperability system can incorporate a new translation layer in front of an existing input layer of the model’s architecture. This first translation layer can convert a request in the standardized format into the specialized format for input to the model. Additionally or alternatively, the interoperability system can incorporate a new translation layer after an existing output layer of the model’s architecture. This second translation layer can convert an output in the specialized format into the standardized format for delivery to another component of the network. In this way, the translation layers can be integrated into the model’s architecture itself and may be updated over time based on changes to its operational configuration.

Through the above features, the interoperability system can provide a robust and adaptive system designed to reconcile differences in operational configurations among machine-learning models. Through automated analysis, dynamic schema generation, bidirectional translation, architectural integration, iterative updates, and conflict resolution, the interoperability system can ensure seamless communication and functionality across diverse machine-learning models and environments.

This introduction is provided to provide the reader with a general understanding of the subject matter discussed herein and is not intended to limit the scope of the disclosed concepts. The following sections describe various additional features and examples with reference to the drawings in which like numerals indicate like elements, but should not be used to limit the present disclosure.

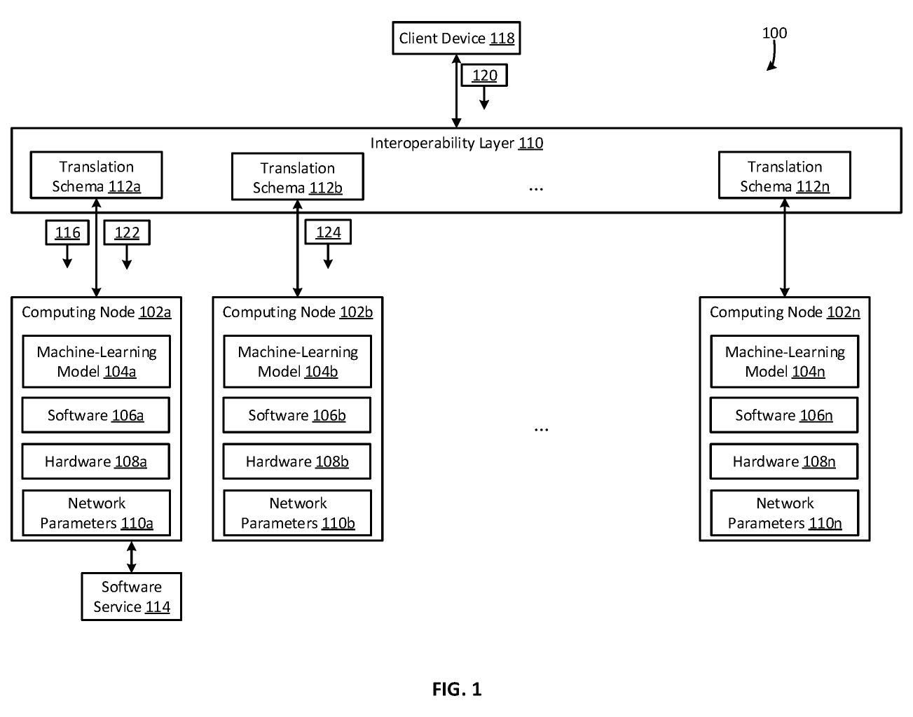

FIG. 1 shows a block diagram of an example of an interoperability system 100 for machine-learning models 104a-n according to some aspects of the present disclosure. The interoperability system 100 can be employed in a network of computing nodes 102a-n. A computing node can include a physical machine or virtual machine. Examples of the computing nodes 102a-n can include servers, laptop computers, desktop computers, tablets, wearable devices (e.g., headsets or glasses), Internet of Things (IoT) devices, or any combination of these. The network can include a private network such as a local area network (LAN), a public network such as the Internet, or any combination thereof. There can be any number of computing nodes 102a-n in the network.

The computing nodes 102a-n can include machine-learning models 104a-n. Examples of the machine-learning models 104a-n can include neural networks, support vector machines, decision trees, large language models (LLMs), generative adversarial networks (GANs), and clustering models. In some scenarios, the machine-learning models 104a-n may originate from the same base model. For example, at least two of the machine-learning models 104a-b may be instances of the same base model, though their operational configurations may differ for various reasons. In other examples, the machine-learning models 104a-n may be different versions of a given model. For instance, the machine-learning models 104a-b may be different versions (e.g., v1.0 and v2.0) of the same model. In still other examples, the machine-learning models 104a-n may be entirely different machine-learning models from one another. For instance, the machine-learning models 104a-b may be different types of machine-learning models created by different entities. Any number and arrangement of machine-learning models can be deployed on the computing nodes 102a-n, including executing multiple machine-learning models on the same computing node.

Besides the machine-learning models 104a-n, the computing nodes 102a-n can also execute other software 106a-n, such as operating systems, services, and application programming interfaces (APIs). The computing nodes 102a-n can also have hardware 108a-n, such as central processing units (CPUs), graphics processing units (GPUs), storage devices, memory devices, and peripheral devices such as cameras, sensors, printers, network adapters, etc. In some examples, at least two of the computing nodes 102a-b may be heterogeneous. For instance, they may have different hardware architectures from one another. Additionally or alternatively, at least two of the computing nodes 102a-b may be homogeneous. For instance, they may have the same hardware architecture as one another. Despite these similarities, the machine-learning models 104a-b executing on the computing nodes 102a-b may still diverge in their operational configurations over time for various reasons, such as access to different endpoints or training data.

As noted above, the machine-learning models 104a-n can exhibit different operational configurations from one another due to various factors. For instance, the machine-learning model 104a may have access to various software services, such as software service 114, which could be executing locally on the computing node 102a or remotely on an external server. Examples of such software services may include a webserver, database system, or other software that provides functionalities or data relied upon by the machine-learning model 104a. In contrast, another machine-learning model 104b may not have access to some or all of those software services. For instance, if the software service 114 is executing on a local subnetwork accessible to computing node 102a, and computing node 102b is part of a separate subnetwork or lacks permissions to access the software service 114, the machine-learning model 104b may be unable to use the software service 114. This difference in access to software services may lead to divergent operational configurations between machine-learning models 104a-b. For example, machine-learning model 104a may have specific settings or features that allow it to integrate with the software service 114, such as an API connection or query capability, while machine-learning model 104b may operate with these settings disabled or altered due to the inaccessibility of the software service 114. Thus, the machine-learning models 104a-b may have variations in their operational configurations due to resource availability and/or other constraints, even if they originate from the same base model.

Additionally or alternatively, the divergence in operational configurations may arise from differences in the software 106a-b and/or hardware 108a-b associated with the computing nodes 102a-b. For example, machine-learning model 104a may be tailored to interact with a specific hardware component, such as a connected peripheral device (e.g., a GPU, sensor, or storage device) available on computing node 102a. In contrast, machine-learning model 104b may lack access to this hardware component, resulting in different or disabled settings. Similarly, the software environment on computing nodes 102a-b may differ significantly, further contributing to operational configuration differences. For instance, machine-learning model 104a may leverage specific features of an operating system running on computing node 102a, while machine-learning model 104b may be constrained by a different operating system or an older version that does not support those features. These differences in software and hardware configurations can lead to variations in how the machine-learning models 104a-b are configured to perform tasks, optimize their operations, or use available resources. As a result, even if the machine-learning models 104a-b are derived from the same base model, their operational configurations may be customized to suit the unique capabilities and limitations of their respective computing environments.

Additionally or alternatively, the operational configurations of the machine-learning models may diverge due to differences in the network parameters 110a-b associated with the computing nodes 102a-b. For instance, machine-learning model 104a may be configured to operate within a high-bandwidth, low-latency network environment accessible to computing node 102a. This configuration may enable features such as real-time data streaming or rapid API calls to external services. On the other hand, machine-learning model 104b may be constrained by a network environment with limited bandwidth, higher latency, or stricter firewall restrictions. As a result, machine-learning model 104b may have certain features disabled or modified to accommodate its network limitations. For example, machine-learning model 104b may rely on batch processing of data instead of real-time streaming or may use offline or locally cached data instead of querying external sources. These network-related differences not only influence the operational configurations of the machine-learning models 104a-b but also reflect the adaptability of the models to varying infrastructure constraints. This adaptability can ensure that the machine-learning models 104a-b can function effectively within their respective environments, even if they originate from the same base model.

Due to the varying operational configurations among the machine-learning models 104a-n (e.g., differences in input parameters, output parameters, input formats, output formats, reliance on specific services and/or hardware, network parameters, API frameworks, and other settings), communication between them may present significant challenges in certain scenarios. For example, machine-learning model 104a may have a specific setting enabled, while machine-learning model 104b has the same setting disabled. This discrepancy could lead machine-learning model 104a to generate an output that is incompatible or unsuitable for machine-learning model 104b, potentially disrupting downstream processes. As another example, machine-learning model 104a may operate with a particular value for a particular setting, whereas machine-learning model 104b may use a different value for the same setting. As a result, machine-learning model 104a may produce an output in a format or structure that machine-learning model 104b cannot process or interpret effectively. These differences in configurations can cause interoperability issues between the models 104a-b.

To address these interoperability problems, some examples of the present disclosure can include an interoperability layer 110. The interoperability layer 110 can be deployed on one or more computing nodes, which may be separate from the computing nodes 102a-n executing the machine-learning models 104a-n. The interoperability layer 110 can enable seamless communication between machine-learning models 104a-n deployed across the computing nodes 102a-n and/or other software programs in the network. The interoperability layer 110 can be configured to bridge the gap created by divergent operational configurations among the machine-learning models 104a-n. In general, the interoperability layer 110 can include several features designed to analyze, translate, and reconcile differences in input formats, output formats, settings, and interaction protocols across the machine-learning models 104a-n.

More specifically, the interoperability layer 110 can automatically analyze the operational configuration of each of the machine-learning models 104a-n. This analysis can involve identifying key operational characteristics of the machine-learning model, such as input parameters, output parameters, input formats, output formats, dependencies on software services and/or hardware, and network parameters. For example, the interoperability layer 110 may communicate (e.g., communication 116) with computing nodes 102a-b to determine the operational configurations of machine-learning models 104a-b. Through these communications, the interoperability layer 110 can determine that machine-learning model 104a relies on a specific API framework to interact with external services, while machine-learning model 104b uses a different framework or interacts with different external services. By systematically mapping these features, the interoperability layer 110 can build a comprehensive operational profile for each model, which can serve as the foundation for generating translation schemas.

Based on the operational configurations identified during the analysis phase, the interoperability layer 110 can generate translation schemas 112a-n tailored to each machine-learning model. These translation schemas 112a-n function as rulesets that define how incoming communications in a standardized format should be converted into a specialized format compatible with a target model. For instance, a translation schema 112a for machine-learning model 104a may include instructions for converting JSON-formatted requests into XML, while the translation schema 112b for machine-learning model 104b may involve mapping specific input fields to different data structures. These translation schemas 112a-n are adaptable and can be updated over time based on the evolution of the machine-learning models 104a-b or their operational configurations.

The interoperability layer 110 can use the translation schemas 112a-n to facilitate bidirectional communication translation, which can help ensure compatibility between the machine-learning models 104a-n and/or other components of the network. For example, the network can receive a request 120 from a client device 118, such as a server, laptop computer, desktop computer, tablet, IOT device, or wearable device. The request 120 can be intended for a machine-learning model 104a. The request 120 can be received in the standardized format. The interoperability layer 110 can receive the request 120, determine that the request 120 is destined for the machine-learning model 104a (e.g., based on the content of the request 120), and apply the relevant translation schema 112a to convert the request 120 from the standardized format into the model’s specialized format. The reformatted request 122 can then be transmitted to the machine-learning model 104a for handling. Based on the inputted request 122, the machine-learning model 104a can generate an output. The output may be in a specialized format associated with the machine-learning model 104a. In some examples, the interoperability layer 110 can translate the output into the standardized format before transmitting it to other components or models in the network. This bidirectional functionality can ensure that the machine-learning models 104a-n can interact effectively, even if their operational configurations differ significantly.

The interoperability layer 110 can adapt to the evolving operational configurations of machine-learning models 104a-b. For example, as the machine-learning models’ operational configurations undergo changes due to continuous learning, updates to software 106a-n or hardware 108a-n, and/or modifications to network parameters 110a-n, the interoperability layer 110 can iteratively update its translation schemas 112a-n accordingly. This iterative process involves periodically reassessing the operational configurations of each machine-learning model and regenerating the corresponding translation schema to reflect the latest changes. For example, if machine-learning model 104a gains access to a new software service or its computing node 102a undergoes a hardware upgrade, the interoperability layer 110 can update the model’s translation schema 112a to accommodate the new capabilities.

Through the above processes, the interoperability layer 110 can resolve conflicts that arise due to differences in model configurations. For example, if machine-learning model 104a generates an output in a format incompatible with machine-learning model 104b, the interoperability layer 110 can ensure that the output is transformed into a compatible format before delivery. Similarly, if a request destined for a first machine-learning model 104a originates from a component configured for use with a second machine-learning model 104b, the interoperability layer 110 can translate the request to align with the requirements of the first machine-learning model 104a. By addressing these conflicts, the interoperability layer 110 can ensure smooth communication and coordination across the models and other software in the network. Whether the network contains homogeneous computing nodes running identical base models or heterogeneous computing nodes operating distinct machine-learning models, the interoperability layer 110 can accommodate the diversity. For example, in a distributed environment involving IoT devices, servers, and edge computing nodes, the interoperability layer 110 can dynamically generate and adjust its translation schemas to account for differences in hardware, software, and network connectivity.

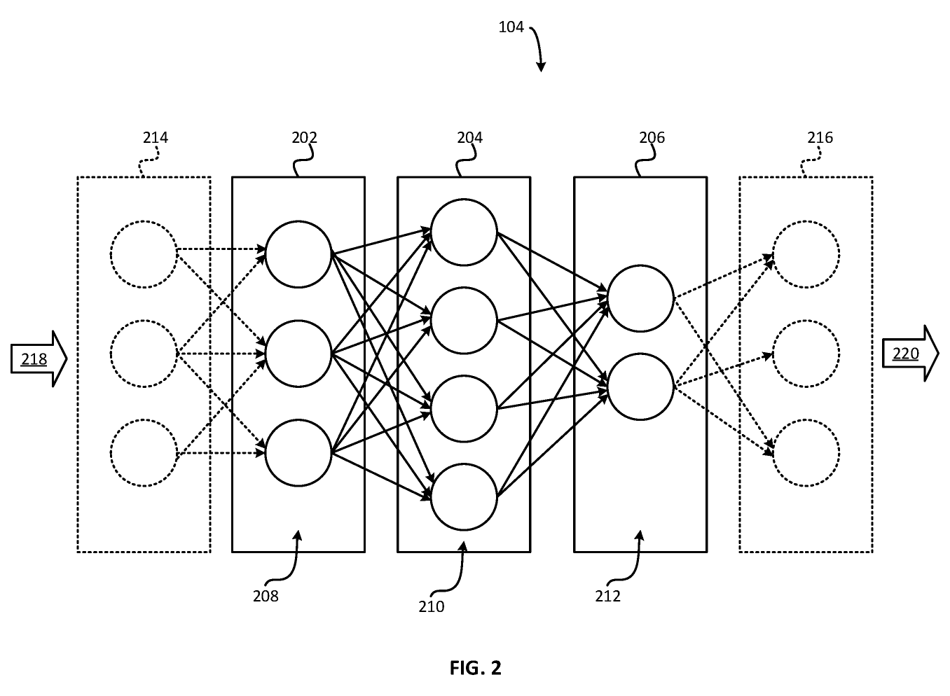

In some examples, to streamline the translation process, the interoperability layer 110 can integrate one or more additional layers directly into the architecture of a machine-learning model. For example, the interoperability layer 110 can insert a translation layer prior to the input layer of a machine-learning model 104a to handle incoming requests. This input translation layer can preprocess the requests, transforming them into the model’s specialized format before forwarding them to the input layer. Additionally or alternatively, a translation layer can be integrated after the model’s output layer to transform the model’s output into a standardized format. By embedding translation layers within the model’s architecture, the interoperability layer 110 minimizes latency and optimizes translation efficiency. This is further described below with reference to FIG. 2.

Turning now to FIG. 2, shown is an example of integrating a translation layer into a machine-learning model’s architecture according to some aspects of the present disclosure. In this example, the machine-learning model 104 may normally include an input layer 202, one or more hidden layers 204, and an output layer 206. For instance, the base model provided to end users by developers may consist of the input layer 202, one or more hidden layers 204, and output layer 206. Within each of the layers 202-206 can be a respective set of nodes, which may have weights that are tuned during a training process.

As described above, in some examples, an input translation layer 214 may be inserted prior to the input layer 202 to translate incoming requests 218 into a format compatible with the machine-learning model 104. For instance, the input translation layer 214 can apply the translation schema to an incoming request 218 to generate a translated request. The input translation layer 214 can then forward the translated request to the input layer 202 of the machine-learning model 104. Additionally or alternatively, an output translation layer 216 may be inserted after the output layer 206 to translate outputs into a standardized format. For instance, the output translation layer 216 can generate a translated output 220 by translating the output of the output layer 206 into the standardized format based on the translation schema. The translated output can then be transmitted to a software program executing on another computing node. These translation layers 214-216 can be retrofitted onto the base model -- e.g., after the base model has been downloaded from an open-source repository or otherwise provided to end users by its developers. The translation layers 214-216 can each have their own respective arrangement of nodes configured (e.g., connected and weighted) to perform their corresponding translations.

In some examples, the translation layers 214-216 can be automatically generated by the interoperability layer 110 based on the corresponding translation schemas. They can then be automatically inserted into the model’s architecture at the appropriate locations.

To generate a translation layer, the interoperability layer 110 can begin by analyzing the translation schema for the machine-learning model 104. The translation schema can contain the rules and mappings to convert inputs and outputs between a standardized format and the specialized format specific to the machine-learning model 104. For example, the schema may define how data fields in a JSON request should be mapped to the model’s required XML format or how the model’s output should be converted into an API-compatible structure. During this step, the interoperability layer 110 can identify key transformations, including data type conversions, field mappings, protocol adjustments, and format-specific requirements.

Next, based on the analysis of the translation schema, the interoperability layer 110 can automatically design the architecture of the translation layer. This can involve determining the appropriate arrangement of nodes and weights within the translation layer to perform the specified transformations effectively. For instance, the input translation layer may include preprocessing nodes configured to parse and reorganize incoming data fields, while the output translation layer may include postprocessing nodes designed to reformat the machine-learning model’s output into the standardized format. The design process can ensure the translation layer can handle the full range of expected inputs and outputs while maintaining compatibility with the machine-learning model’s operational configuration. In some examples, the design process can rely on predefined templates configured to implement various translation functions. During the design process, the appropriate predefined templates can be selected and arranged to arrive at the desired target functionality of the translation layer.

Once the design is finalized, the interoperability layer 110 can automatically generate the code to implement the translation layer. This code can be written in a language compatible with the machine-learning model’s framework (e.g., Python for TensorFlow or PyTorch, C++, etc.). The generated code can define the logic for executing the transformations specified in the translation schema, including data parsing, validation, mapping, and restructuring operations. After generating the code, the interoperability layer 110 can compile it into an executable format that can be integrated into the machine-learning model’s architecture. For example, the input translation layer 214 can be inserted prior to the model’s input layer 202, while the output translation layer 216 can be inserted after the model’s output layer 206. This integration may involve modifying the model’s configuration files or using hooks to attach the translation layers 214-216 to the appropriate layers in the model’s architecture. After integration, the interoperability layer 110 can perform automated testing and validation to ensure the translation layers 214-216 function correctly. This can involve running sample inputs and outputs through the translation layers 214-216 and verifying that the transformations align with the rules defined in the translation schema.

As the machine-learning model’s 104 operational configuration evolves over time, the interoperability layer 110 can iteratively update the translation schema to reflect these changes. For example, the machine-learning model 104 may gain access to new software services, adopt a different API framework, or undergo additional training. To account for these updates, the interoperability layer 110 can generate one or more new translation layers based on the revised schema. The updated translation layers can then be integrated into the model’s architecture, replacing the previous layers as needed. For example, the interoperability layer 110 can generate a new input translation layer based on an update to the model’s translation schema. The interoperability layer 110 can then replace the existing input translation layer 214 with the new input translation layer in the model’s architecture. This iterative process ensures that the translation layers remain compatible with the machine-learning model’s evolving requirements.

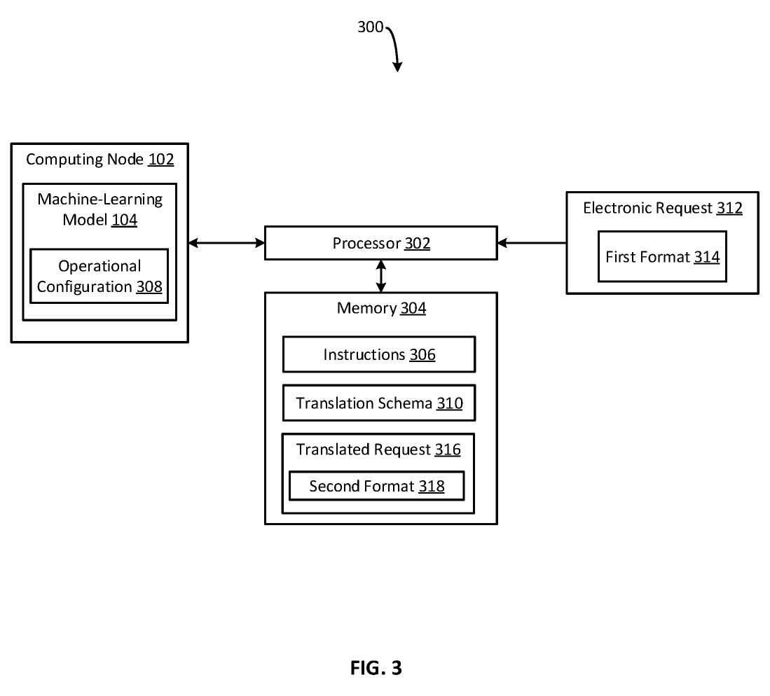

Turning now to FIG. 3, shown is a block diagram of an example of an interoperability system 300 for machine-learning models according to some aspects of the present disclosure. The interoperability system 300 can include a processor 302 communicatively coupled to a memory 304 by a bus. The processor 302 can include one processing device or multiple processing devices. Non-limiting examples of the processor 302 include a Field-Programmable Gate Array (FPGA), an application-specific integrated circuit (ASIC), a microprocessor, or any combination of these. The processor 302 can execute instructions 306 stored in the memory 304 to perform operations, such as any of the operations described above with respect to FIGS. 1-2. In some examples, the instructions 306 can include processor-specific instructions generated by a compiler or an interpreter from code written in any suitable computer-programming language, such as C, C++, C#, Python, or Java.

The memory 304 can include one memory device or multiple memory devices. The memory 304 can be volatile or non-volatile, such that the memory 304 retains stored information when powered off. Non-limiting examples of the memory 304 include electrically erasable and programmable read-only memory (EEPROM), flash memory, or any other type of non-volatile memory. At least some of the memory device includes a non-transitory computer-readable medium from which the processor 302 can read the instructions 306. A computer-readable medium can include electronic, optical, magnetic, or other storage devices capable of providing the processor 302 with computer-readable instructions or other program code. Non-limiting examples of a computer-readable medium can include magnetic disks, memory chips, ROM, random-access memory (RAM), an ASIC, a configured processor, optical storage, or any other medium from which a computer processor can read the instructions 306.

The processor 302 can execute the instructions 306 to perform operations, such as the operations of the interoperability layer described above. For example, the processor 302 can automatically analyze an operational configuration 308 for a machine-learning model 104 executing on a computing node 102. The processor 302 can generate a translation schema 310 for the machine-learning model 104 based on the operational configuration 308. The processor 302 can then receive an electronic request 312 in a first format 314 (e.g., a standardized format). The electronic request 312 may originate from a client device. The electronic request 312 can be intended for the machine-learning model 104. The processor 302 can generate a translated request 316 by translating the electronic request 312 from the first format 314 into a second format 318 (e.g., a specialized format) based on the translation schema 310. The second format 318 is different from the first format 314. The processor 302 can then transmit the translated request 316 to the machine-learning model 104 for processing.

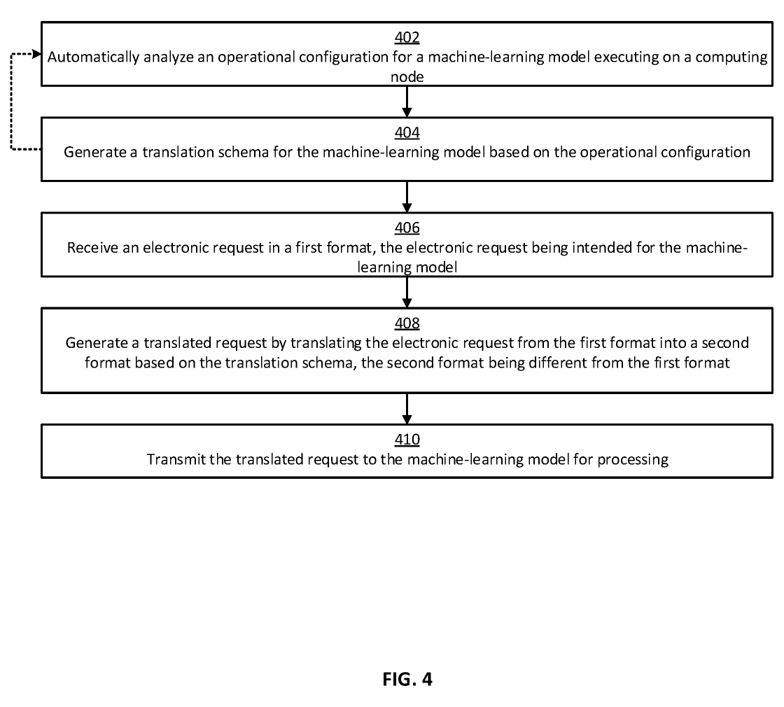

Turning now to FIG. 4, shown is a flowchart of an example of a process for enabling interoperability between machine-learning models according to some aspects of the present disclosure. Other examples may involve more operations, fewer operations, different operations, or a different sequence of the operations shown in FIG. 4. The operations of FIG. 4 are described below with reference to the components of FIG. 3 described above.

In block 402, the processor 302 automatically analyzes an operational configuration 308 for a machine-learning model 104 executing on a computing node 102. This may involve the processor 302 requesting information about the operating configuration of the model 104 from the computing node 102 (or another source). In response to receiving the request, the computing node 102 can perform an introspection process to determine the operational configuration 308 for the machine-learning model 104. The computing node 102 can then transmit the information about the operational configuration 308 back to the processor 302. Based on receiving that information, the processor 302 can determine the operational configuration 308 for the machine-learning model 104.

In block 404, the processor 302 generates a translation schema 310 for the machine-learning model 104 based on the operational configuration 308. The translation schema 310 can serve as a set of rules or mappings that enable the conversion of data between a first format 314 and a second format 318 specific to the operational configuration 308 of the target model 104. This translation schema 310 can be tailored to account for various aspects of the model’s operational configuration 308, such as the model’s input parameters, output parameters, dependencies on specific software or hardware, and network-related constraints. For example, the processor 302 can analyze the model’s operational configuration 308 to determine structured rules and mappings, such as field mappings, data type conversions, and protocol adjustments, which define how incoming data should be translated for compatibility with the model 104.

In some examples, the processor 302 can determine the second format 318 associated with the machine-learning model 104 by analyzing the operational configuration 308. The processor 302 can next determine differences between the second format 318 and a first format 314, which can be predefined. The processor 302 can then generate a translation schema 310 that resolves those differences.

In some examples, blocks 402-404 can iterate over time, as represented by the dashed arrow in FIG. 4. For instance, the processor 302 can perform operations 402-404 at a periodic interval (e.g., monthly) or in response to detecting certain events, which may be indicative of changes to the model’s operating configuration. This can allow the processor 302 to update the translation schema 310 for the machine-learning model 104 as the model’s operational configuration 308 changes over time. To that end, in some examples, the processor 302 can determine an updated operational configuration for the machine-learning model 104. The processor 302 can then compare the updated operational configuration for the machine-learning model 104 with a prior operational configuration of the machine-learning model 104, where the prior operational configuration was determined during a prior iteration of the iterative process. Based on this comparison, the processor 302 can determine a difference between the updated operational configuration and the prior operational configuration. The processor 302 can then generate the updated translation schema based on the difference.

In block 406, the processor 302 receives an electronic request 312 in a first format 314. The electronic request 312 can be intended for the machine-learning model 104. The processor 302 can receive the electronic request 312 from a client device via a network.

In block 408, the processor 302 generates a translated request 316 by translating the electronic request 312 from the first format 314 into a second format 318 based on the translation schema 310. The second format 318 is different from the first format 314.

In block 410, the processor 302 transmits the translated request 316 to the machine-learning model 104 for processing. Based on receiving the translated request 316, the machine-learning model 104 can generate an output. The output, in turn, may be translated into the first format 314 using a translation schema, which may be the same as or different from the translation schema 310 used for input translation.

It will be appreciated that although various examples described above relate to translating communications between machine-learning models, similar principles could be applied to communications with or between other types of software programs. For example, two instances of the same webserver deployed on different computing nodes may have divergent operating configurations for various reasons, leading to interoperability problems that may be solved by the techniques described herein. Therefore, the present disclosure is not intended to be limited just to communications between machine-learning models.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A non-transitory computer-readable medium comprising program code that is executable by one or more processors for causing the one or more processors to perform operations including:
automatically analyzing an operational configuration for a machine-learning model executing on a computing node;
generating a translation schema for the machine-learning model based on the operational configuration;
receiving an electronic request in a first format, the electronic request being intended for the machine-learning model;
generating a translated request by translating the electronic request from the first format into a second format based on the translation schema, the second format being different from the first format; and
transmitting the translated request to the machine-learning model for processing.

2. The non-transitory computer-readable medium of claim 1, wherein the operations further comprise:
automatically updating the translation schema over time based on one or more changes to the operational configuration of the machine-learning model on the computing node.

3. The non-transitory computer-readable medium of claim 2, wherein the operations further comprise an iterative process performed over time, wherein each iteration involves:
determining an updated operational configuration for the machine-learning model by communicating with the computing node; and
generating an updated translation schema based on the updated operational configuration, the updated translation schema being usable for translating subsequent requests from the first format to a corresponding format for the machine-learning model.

4. The non-transitory computer-readable medium of claim 3, wherein the operations further comprise:
comparing the updated operational configuration with a prior operational configuration to determine a difference between the updated operational configuration and the prior operational configuration, wherein the prior operational configuration was determined during a prior iteration of the iterative process; and
generating the updated translation schema based on the difference.

5. The non-transitory computer-readable medium of claim 1, wherein the operational configuration includes:
one or more input parameters to the machine-learning model; and
one or more output parameters from the machine-learning model.

6. The non-transitory computer-readable medium of claim 1, wherein the operational configuration includes software services used by the machine-learning model, wherein the software services are separate from the machine-learning model, and wherein the software services include a first service on the computing node and a second service external to the computing node.

7. The non-transitory computer-readable medium of claim 1, wherein the operational configuration includes one or more hardware components used by the machine-learning model.

8. The non-transitory computer-readable medium of claim 1, wherein the operational configuration includes one or more application programming interface (API) frameworks used by the machine-learning model to interface with one or more endpoints.

9. The non-transitory computer-readable medium of claim 1, wherein the operational configuration includes one or more network parameters used by the machine-learning model.

10. The non-transitory computer-readable medium of claim 1, wherein the operations further comprise:
integrating a translation layer into an architecture of the machine-learning model, the translation layer being inserted into the architecture prior to an input layer of the machine-learning model, the translation layer being configured to:
apply the translation schema to the electronic request to generate the translated request; and
forward the translated request to the input layer of the machine-learning model.

11. The non-transitory computer-readable medium of claim 1, wherein the operations further comprise:
receiving an output from the machine-learning model, the output being generated by the machine-learning model in response to the translated request;
generating a translated output by translating the output into the first format based on the translation schema; and
transmitting the translated output to a software program executing on another computing node.

12. The non-transitory computer-readable medium of claim 11, wherein the operations further comprise:
integrating a translation layer into an architecture of the machine-learning model, the translation layer being integrated into the architecture after an output layer of the machine-learning model, the translation layer being configured to apply the translation schema to the output to generate the translated output.

13. A method comprising:
automatically, by one or more processors, analyzing an operational configuration for a machine-learning model executing on a computing node;
generating, by the one or more processors, a translation schema for the machine-learning model based on the operational configuration;
receiving, by the one or more processors, an electronic request in a first format, the electronic request being intended for the machine-learning model;
generating, by the one or more processors, a translated request by translating the electronic request from the first format into a second format based on the translation schema, the second format being different from the first format; and
transmitting, by the one or more processors, the translated request to the machine-learning model for processing.

14. The method of claim 13, further comprising automatically updating the translation schema over time based on changes to the operational configuration of the machine-learning model on the computing node.

15. The method of claim 14, further comprising an iterative process performed over time, wherein each iteration involves:
determining an updated operational configuration for the machine-learning model by communicating with the computing node; and
generating an updated translation schema based on the updated operational configuration, the updated translation schema being usable for translating subsequent requests from the first format to a corresponding format for the machine-learning model.

16. The method of claim 15, further comprising:
comparing the updated operational configuration with a prior operational configuration determined during a prior iteration of the iterative process, to determine a difference between the updated operational configuration and the prior operational configuration; and
generating the updated translation schema based on the difference.

17. The method of claim 13, further comprising:
integrating a translation layer into an architecture of the machine-learning model, the translation layer being inserted into the architecture prior to an input layer of the machine-learning model, the translation layer being configured to:
apply the translation schema to the electronic request to generate the translated request; and
forward the translated request to the input layer of the machine-learning model.

18. The method of claim 13, further comprising:
receiving an output from the machine-learning model, the output being generated by the machine-learning model in response to the translated request;
generating a translated output by translating the output into the first format based on the translation schema; and
transmitting the translated output to a software program executing on another computing node.

19. The method of claim 18, further comprising:
integrating a translation layer into an architecture of the machine-learning model, the translation layer being integrated into the architecture after an output layer of the machine-learning model, the translation layer being configured to apply the translation schema to the output to generate the translated output.

20. A system comprising:
one or more processors; and
one or more memories storing instructions that are executable by the one or more processors for causing the one or more processors to perform operations including:
automatically analyzing an operational configuration for a machine-learning model executing on a computing node;
generating a translation schema for the machine-learning model based on the operational configuration;
receiving an electronic request in a first format, the electronic request being intended for the machine-learning model;
generating a translated request by translating the electronic request from the first format into a second format based on the translation schema, the second format being different from the first format; and
transmitting the translated request to the machine-learning model for processing.
